(19) United States
(12) Patent Application Publication
(10) Pub. No.: US 2026/0054286 A1
(43) Pub. Date: Feb. 26, 2026

(54) PLANARIZATION SYSTEM, PLANARIZATION METHOD, AND ARTICLE MANUFACTURING METHOD

(71) Applicant: CANON KABUSHIKI KAISHA, Tokyo (JP)

(72) Inventor: MASAKI SAITO, Tochigi (JP)

(21) Appl. No.: 19/297,363

(22) Filed: Aug. 12, 2025

(30) Foreign Application Priority Data
Aug. 23, 2024 (JP) 2024-143353
Aug. 23, 2024 (JP) 2024-143354

(51) Int. Cl. B05D 1/00; B05C 9/14; B05C 13/00

(52) U.S. Cl. CPC B05D 1/005; B05C 9/14; B05C 13/00

(57) ABSTRACT

A planarization system includes a spin coater configured to form a liquid film on a substrate by a spin coating method, a heat treatment apparatus configured to perform a heat treatment for curing the liquid film formed by the spin coater, a droplet arrangement apparatus configured to arrange a plurality of droplets of a curable composition on the substrate, a planarization apparatus configured to form a planarization film by bringing a superstrate into contact with the plurality of droplets of the curable composition arranged on the substrate by the droplet arrangement apparatus, and a conveyance mechanism configured to convey the substrate to the spin coater, the heat treatment apparatus, the droplet arrangement apparatus, and the planarization apparatus in this order.

### BACKGROUND

### Field of the Technology The present disclosure relates to a planarization system, a planarization method, and an article manufacturing method.

### Description of the Related Art

There is known a planarization technique in which a curable composition is arranged on a substrate, and the curable composition is molded using a member called a superstrate and then cured, thereby forming a planarization film (for example, Japanese Patent Laid-Open No. 2020-145354).

In the above-described planarization technique, the upper surface of the curable composition before curing is planarized conforming to the lower surface of the superstrate. However, when the curable composition is cured, it shrinks, and a small height difference may be generated on the surface of the curable composition. This height difference depends on the height difference of the surface of the substrate, in other words, the distance between the surface of the substrate and the lower surface of the superstrate. That is, the curable composition is arranged thick on a low region of the surface of the substrate and thin on a high region of the surface of the substrate. The thicker the curable composition is, the larger the shrinkage amount in curing is, and the thinner the curable composition is, the smaller the shrinkage amount in curing is. For this reason, a height difference may be generated on the surface of the curable composition after curing due to the difference of the shrinkage amount.

### SUMMARY

The present disclosure provides a technique advantageous in improving the accuracy of planarization.

A first aspect of the present disclosure provides a planarization system comprising: a spin coater configured to form a liquid film on a substrate by a spin coating method; a heat treatment apparatus configured to perform a heat treatment for curing the liquid film formed by the spin coater; a droplet arrangement apparatus configured to arrange a plurality of droplets of a curable composition on the substrate; a planarization apparatus configured to form a planarization film by bringing a superstrate into contact with the plurality of droplets of the curable composition arranged on the substrate by the droplet arrangement apparatus; and a conveyance mechanism configured to convey the substrate to the spin coater, the heat treatment apparatus, the droplet arrangement apparatus, and the planarization apparatus in this order.

A second aspect of the present disclosure provides a planarization system comprising: a planarization apparatus configured to form a planarization film by bringing a superstrate into contact with a curable composition arranged on a substrate; a droplet arrangement apparatus configured to arrange a plurality of droplets on the substrate; a heat treatment apparatus configured to, after the plurality of droplets arranged on the substrate by the droplet arrangement apparatus bond to each other to form a liquid film, further perform a heat treatment for curing the liquid film and a heat treatment for further curing the planarization film formed by the planarization apparatus; and a conveyance mechanism configured to convey the substrate to the droplet arrangement apparatus, the heat treatment apparatus, the droplet arrangement apparatus, the planarization apparatus, and the heat treatment apparatus in this order.

A third aspect of the present disclosure provides a planarization method comprising: forming a first planarization film by forming a liquid film on a substrate and curing the liquid film in a state in which an upper surface of the liquid film is exposed to a space above the liquid film; and forming a second planarization film by a curable composition on the first planarization film using a superstrate.

A fourth aspect of the present disclosure provides an article manufacturing method comprising: forming a first planarization film and a second planarization film on a substrate by a planarization method defined as the third aspect; and processing the substrate with the first planarization film and the second planarization film formed thereon, thereby obtaining an article.

Features of the present disclosure will become apparent from the following description of embodiments with reference to the attached drawings. The following description of embodiments is described by way of example.

### BRIEF DESCRIPTION OF THE DRAWINGS

FIGS. 1A to 1F are views schematically showing a planarization method and an article manufacturing method according to the first embodiment;

FIGS. 2A to 2F are views schematically showing a planarization method and an article manufacturing method according to the second embodiment;

FIG. 3 is a plan view schematically showing the configuration of a planarization system according to the third embodiment;

FIG. 4 is a plan view schematically showing the configuration of a planarization system according to the fourth embodiment;

FIG. 5 is a plan view schematically showing the configuration of a planarization system according to the fifth embodiment;

FIG. 6 is a plan view schematically showing the configuration of a planarization system according to the sixth embodiment;

FIG. 7 is a plan view schematically showing the configuration of a planarization system according to the seventh embodiment;

FIG. 8 is a plan view schematically showing the configuration of a planarization system according to the eighth embodiment;

FIG. 9 is a plan view schematically showing the configuration of a planarization system according to the ninth embodiment;

FIG. 10 is a plan view schematically showing the configuration of a planarization system according to the 10th embodiment; and FIG. 11 is a plan view schematically showing the configuration of a planarization system according to the 11th embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

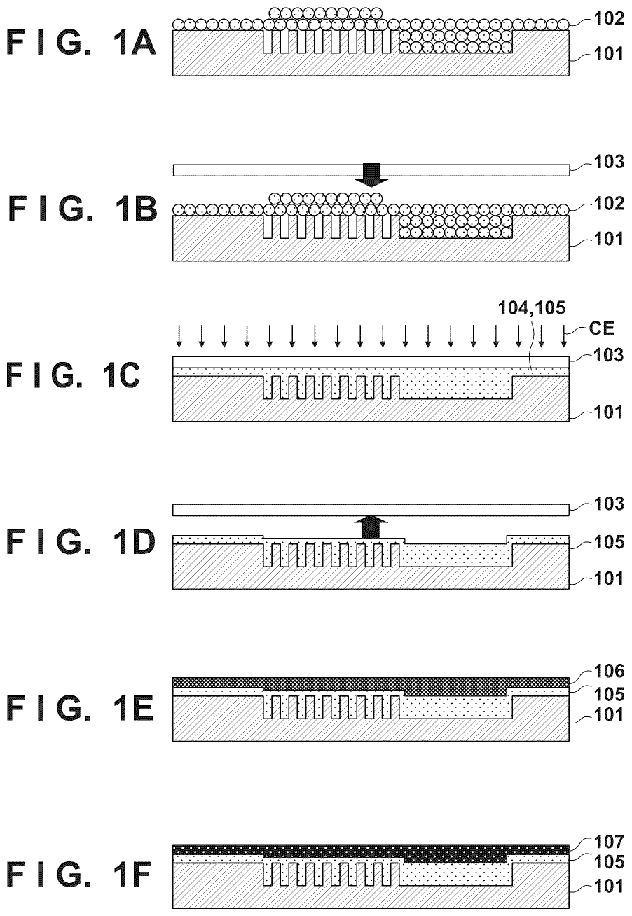

The first embodiment will be described below. FIGS. 1A to 1F schematically show a planarization method and an article manufacturing method according to the first embodiment. The planarization method and the article manufacturing method according to the first embodiment can include a first step and a second step.

In the first step, a planarization film 105 (first planarization film) is formed by a curable composition 102 on a substrate 101 using a superstrate 103. In the second step, a liquid film 106 is formed on the planarization film 105, and the liquid film 106 is cured in a state in which the upper surface of the liquid film 106 is exposed to the space above the liquid film 106, thereby forming a planarization film 107 (second planarization film). The second step is executed without bringing the upper surface of the liquid film 106 into contact with a solid member such as the superstrate 103. Hence, in the second step, the upper surface of the liquid film 106 and the upper surface of the planarization film 107 do not conform to the lower surface of the solid member. For this reason, the shape or unevenness of the lower surface of the solid member or a foreign substance adhered to the solid member is not transferred to the upper surface of the planarization film 107. Hence, the planarity of the surface of the planarization film 107 (second planarization film) of a second layer formed by executing the second step is higher than the planarity of the surface of the planarization film 105 (first planarization film) of a first layer.

As the material of the substrate 101, for example, glass, ceramics, a metal, a semiconductor (Si, GaN, SiC, or the like), a resin, or the like can be used. The substrate 101 may have one or a plurality of layers on a base material such as a wafer, as needed. Normally, nonnegligible unevenness may exist on the surface of the substrate 101 that is the target of planarization.

The curable composition 102 is a material that is cured by receiving curing energy CE. As the curing energy CE, an electromagnetic wave, heat, or the like can be used. The electromagnetic wave can be, for example, light whose wavelength is selected from the range of 10 nm or more and 1 mm or less, for example, infrared rays, visible light, ultraviolet rays, and the like. The curable composition 102 contains at least a polymerizable compound and a photopolymerization initiator, and may further contain a nonpolymerizable compound or a solvent, as needed. The nonpolymerizable compound is at least one type of material selected from the group consisting of a sensitizer, a hydrogen donor, an internal mold release agent, a surfactant, an antioxidant, a polymer component, and the like. The curable composition 102 can be arranged, on the substrate, as droplets or as an island pattern or a film formed by connecting a plurality of droplets. Alternatively, the curable composition 102 may be supplied in a film shape onto the substrate by a spin coater or a slit coater. The viscosity (the viscosity at 25° C.) of the curable composition 102 can be, for example, 1 mPa·s or more and 100 mPa·s or less.

A more detailed example of the first step will be described below with reference to FIGS. 1A to 1D. First, in an arranging step shown in FIG. 1A, a plurality of droplets of the curable composition 102 can be arranged on the substrate 101. Next, in a contact step shown in FIG. 1B, the superstrate 103 is brought into contact with the plurality of droplets of the curable composition 102 arranged on the substrate 101, thereby forming a composition film 104 formed by the bond of the plurality of droplets. In a photocuring step shown in FIG. 1C, the composition film 104 is irradiated with light as the curing energy CE and thus cured. The planarization film 105 made of a cured product of the curable composition 102 (composition film 104) can thus be formed. After that, in a separation step shown in FIG. 1D, the superstrate 103 can be separated from the planarization film 105. That is, the first step can include the arranging step, the contact step, and the photocuring step. Alternatively, the first step can include the arranging step, the contact step, the photocuring step, and the separation step. The first step may further include a heat curing step of heating the composition film 104 (planarization film 105) that has undergone the photocuring step, thereby further curing the composition film 104 (planarization film 105). In this case, the separation step of separating the superstrate 103 from the planarization film 105 may be executed before the heat curing step or after the heat curing step. If unevenness exists on the surface of the substrate 101, small unevenness of, for example, 10 nm or less may be formed on the surface of the planarization film 105 (first planarization film).

The planarization method and the article manufacturing method according to the first embodiment may further include a step of forming an adhesion layer (not shown) on the substrate 101. In this case, in the first step, the planarization film 105 can be formed on the adhesion layer.

A more detailed example of the second step will be described below with reference to FIGS. 1E and 1F. First, in a liquid film forming step shown in FIG. 1E, the liquid film 106 can be formed on the planarization film 105 (first planarization film). Next, in a curing step shown in FIG. 1F, the liquid film 106 is cured in a state in which the upper surface of the liquid film 106 is exposed to the space above the liquid film 106, thereby forming the planarization film 107 (second planarization film). The unevenness of the surface of the planarization film 107 (second planarization film) can be suppressed to, for example, several nm or less.

Three methods (a first method, a second method, and a third method) for executing the second step will be described here.

### First Method

In the first method, the second step can include the liquid film forming step of forming the liquid film 106 on the planarization film 107 by a spin coating method (FIG. 1E), and the curing step of curing the liquid film 106 in a state in which the upper surface of the liquid film 106 is exposed to the space above the liquid film 106 (FIG. 1F). The material that forms the liquid film 106 can be, for example, a Spin On Carbon (SOC) material or a Spin On Glass (SOG) material. The curing step can include a liquid film curing step of curing the liquid film 106 by heating the liquid film 106. If the first step includes the heat curing step, the heat curing step of the first step and the liquid film curing step of the second step may be executed by the same heat treatment apparatus or different heat treatment apparatuses.

### Second Method

In the second method, the second step can include the liquid film forming step of forming the liquid film 106 (FIG. 1E), and the curing step of curing the liquid film 106 in a state in which the upper surface of the liquid film 106 is exposed to the space above the liquid film 106 (FIG. 1F). The liquid film forming step can include a film forming step of forming a first liquid material film made of a first liquid material on the planarization film 105. The liquid film forming step can also include an arranging step of arranging a plurality of droplets made of a second liquid material on the first liquid material film, and a waiting step of waiting until a film made of the first liquid material and the second liquid material is formed as the liquid film 106. The curing step can include the liquid film curing step of curing the liquid film 106 by heating the liquid film 106. If the first step includes the heat curing step, the heat curing step of the first step and the liquid film curing step of the second step may be executed by the same heat treatment apparatus or different heat treatment apparatuses.

Japanese Patent Laid-Open No. 2023-539968 describes a first liquid curable composition (A1) as the first liquid material and a second liquid curable composition (A2) as the second liquid material. All matters described in Japanese Patent Laid-Open No. 2023-539968 are incorporated herein by reference as if disclosed herein.

The liquid curable composition (A1) contains a solvent component (d1). This is because the spin coating method is preferable as a method of applying the liquid curable composition (A1) to the substrate. For this reason, the content of the solvent component (d1) is preferably 90 wt % or more and 99.99 wt % or less and particularly preferably 99 wt % or more and 99.9 wt % or less. As the solvent component (d1) of the liquid curable composition (A1), a solvent which dissolves a component (a1), a component (b1), and a component (c1) and whose surface tension is lower than that of a mixture made of the component (a1), the component (b1), and the component (c1) is used. The lower the surface tension of the solvent component (d1) is, the more even a film that can be obtained by the spin coating method is. A more preferable solvent is a solvent whose boiling point at normal pressure is 80° C. or more and 200° C. or less. A more favorable solvent is a solvent having at least one of an ester structure, a ketone structure, a hydroxyl group, and an ether structure. More specifically, the solvent is a single solvent selected from propylene glycol monomethyl ether acetate, propylene glycol monomethyl ether, cyclohexanone, 2-heptanone, γ-butyrolactone, and ethyl lactate or a solvent mixture thereof.

The liquid curable composition (A2) may also contain a solvent as a component (d2). The component (d2) to be added to the liquid curable composition (A2) is not particularly limited if it is a solvent that dissolves a component (a2), a component (b2), and a component (c2). A preferable solvent is a solvent whose boiling point at normal pressure is 80° C. or more and 200° C. or less. A more favorable solvent is a solvent having at least one of an ester structure, a ketone structure, a hydroxyl group, and an ether structure. More specifically, the solvent is a single solvent selected from propylene glycol monomethyl ether acetate, propylene glycol monomethyl ether, cyclohexanone, 2-heptanone, γ-butyrolactone, and ethyl lactate or a solvent mixture thereof.

(Third Method) In the third method, the second step can include the liquid film forming step of forming the liquid film 106 (FIG. 1E), and the curing step of curing the liquid film 106 in a state in which the upper surface of the liquid film 106 is exposed to the space above the liquid film 106 (FIG. 1F). The liquid film forming step can include an arranging step of arranging a plurality of droplets made of a liquid material on the planarization film 105, and a waiting step of waiting until the liquid film 106 is formed by the plurality of droplets in a state in which the plurality of droplets are exposed to the space above the liquid film 106. The curing step can include the liquid film curing step of curing the liquid film 106 by heating the liquid film 106. If the first step includes the heat curing step, the heat curing step of the first step and the liquid film curing step of the second step may be executed by the same heat treatment apparatus or different heat treatment apparatuses.

Japanese Patent Laid-Open No. 2023-090491 describes a curable composition (A) that is a liquid material. All matters described in Japanese Patent Laid-Open No. 2023-090491 are incorporated herein by reference as if disclosed herein.

The curable composition (A) is a composition containing at least a component (a) that is a polymerizable compound. The curable composition (A) may further contain a component (b) that is a polymerization initiator, a nonpolymerizable compound (c), and a component (d) that is a solvent. The components (a) to (c) can be nonvolatile components, and the component (d1) can be a volatile component.

The component (a) is a polymerizable compound. The polymerizable compound is a compound that reacts with a polymerization factor (for example, a radical) generated from the polymerization initiator (component (b)), and forms a film made of a polymer compound by a chain reaction (polymerization reaction). A compound that spontaneously generates a polymerization factor upon heating and polymerizes can also be used as the component (a). An example of the polymerizable compound is, for example, a radical polymerizable compound. The polymerizable compound as the component (a) may be formed by only one type of polymerizable compound or a plurality of types of polymerizable compounds. Examples of the radical polymerizable compound are a (meth)acrylic compound, a styrene-based compound, a vinyl-based compound, an allylic compound, a fumaric compound, and a maleic compound.

The component (b) is a polymerization initiator. The polymerization initiator may be a photopolymerization initiator or a thermal polymerization initiator. The photopolymerization initiator is a compound that senses light having a predetermined wavelength and generates a polymerization factor (radical) described earlier. More specifically, the photopolymerization initiator is a polymerization initiator (radical generator) that generates a radical by light (infrared rays, visible light, ultraviolet rays, far-ultraviolet rays, X-rays, a charged particle beam such as an electron beam, or radiation). The thermal polymerization initiator is a polymerization initiator (radical generator) that generates a radical upon heating. The component (b) may be formed by only one type of polymerization initiator or a plurality of types of polymerization initiators.

The component (c) can further contain a nonpolymerizable compound. An example of the component (c) is a compound that does not contain a polymerizable functional group such as a (meth)acryloyl group and does not have the ability to sense light having a predetermined wavelength and generate the polymerization factor (radical) described previously. Examples of the nonpolymerizable compound are a sensitizer, a hydrogen donor, an internal mold release agent, an antioxidant, a polymer component, and other additives. The component (c) may contain a plurality of types of above-described compounds.

The component (d) is a volatile component and contains a solvent whose boiling point at normal pressure is 80° C. or more and less than 250° C. The component (d) is a solvent that dissolves the component (a), the component (b), and the component (c), and examples are an alcohol-based solvent, a ketone-based solvent, an ether-based solvent, an ester-based solvent, and a nitrogen-containing solvent. As the component (d), it is possible to use a single type of component or two or more types of components in combination. That is, the component (d) can contain one or more types of solvents. The boiling point of the component (d) at normal pressure is preferably 80° C. or more and 140° C. or less. If the boiling point of the component (d) at normal pressure is less than 80° C., the volatilization speed in the waiting step is too high. For this reason, the component (d) may volatilize before the droplets of the curable composition (A) bond to each other, and the droplets of the curable composition (A) may not bond to each other. Also, if the boiling point of component (d) at normal pressure is 250° C. or more, volatilization of the solvent (d) may be insufficient in the waiting step, and the component (d) may remain in the cured product of the curable composition (A).

The article manufacturing method according to the first embodiment includes, after the step of forming the planarization film 105 of the first layer and the planarization film 107 of the second layer by the planarization method exemplarily shown in FIGS. 1A to 1F, a processing step of processing the substrate with the planarization film 105 of the first layer and the planarization film 107 of the second layer formed thereon, thereby obtaining an article. The processing step can include, for example, a step of forming a photoresist film on the planarization film 107 of the second layer, a step of transferring a pattern of a reticle to the photoresist film using an exposure apparatus, and a step of obtaining a resist pattern by developing the transferred pattern. Here, after formation of the planarization film 107 of the second layer and before formation of the photoresist film, a pattern target film may be formed. Alternatively, before formation of the planarization film 105 of the first layer, the substrate 101 may have a pattern target film. The pattern target film may be patterned by multiple patterning such as double patterning or quadruple patterning using a resist pattern formed thereon. The pattern target film may be a film used to form a hard mask.

The processing step can include, for example, a step of forming a fin structure by patterning an underlying structure, for example, a stacked structure formed by alternately stacking a silicon layer and a silicon germanium layer a plurality of times. The processing step can further include a step of forming a nanowire by processing the fin structure, and a step of forming a gate insulating film covering the nanowire, and a gate electrode. By these steps, a GAA transistor having a Gate All Around (GAA) structure can be formed.

### Second Embodiment

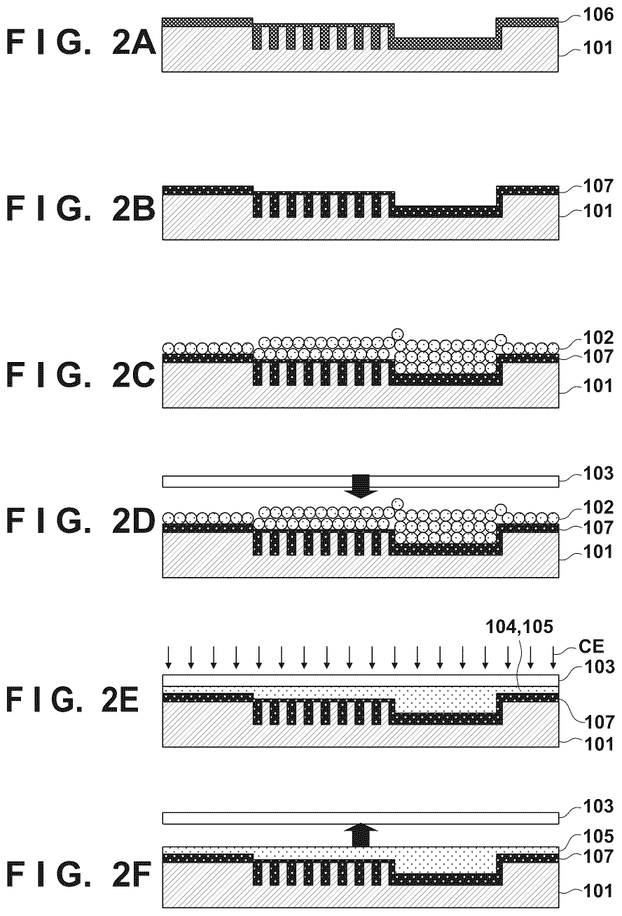

The second embodiment will be described below. FIGS. 2A to 2F schematically show a planarization method and an article manufacturing method according to the second embodiment. Matters that are not mentioned in the explanation of the second embodiment can comply with the explanation of the first embodiment.

The planarization method and the article manufacturing method according to the second embodiment can include a first step and a second step. In the first step, a liquid film 106 is formed on a substrate 101, and the liquid film 106 is cured in a state in which the upper surface of the liquid film 106 is exposed to the space above the liquid film 106, thereby forming a planarization film 107 (first planarization film). In the second step, a planarization film 105 (second planarization film) is formed by a curable composition 102 on the planarization film 107 using a superstrate 103. That is, in the second embodiment, the first step and the second step in the first embodiment are replaced with each other.

In the second embodiment, the first step is executed without bringing the upper surface of the liquid film 106 into contact with a solid member such as the superstrate 103. Hence, in the first step, the upper surface of the liquid film 106 and the upper surface of the planarization film 107 do not conform to the lower surface of the solid member. For this reason, the shape or unevenness of the lower surface of the solid member or a foreign substance adhered to the solid member is not transferred to the upper surface of the planarization film 107. However, the height difference of the upper surface of the planarization film 107 of the first layer formed in the first step according to the second embodiment may be larger than the height difference of the upper surface of the planarization film 105 of the first layer formed in the first step according to the first embodiment.

In the second embodiment, the planarity of the surface of the planarization film 105 (second planarization film) of the second layer obtained by executing the second step is much higher than the planarity of the surface of the planarization film 107 (first planarization film) of the first layer. In addition, since the second step of forming the planarization film 105 (second planarization film) using the superstrate 103 is executed after the planarization film 107 (first planarization film) is formed in the first step, the filling step of the curable composition 102 can be completed in a time shorter than in the first embodiment. The filling step of the curable composition 102 is a step of filling the curable composition 102 in a space defined by the superstrate 103 and a face facing that (in the second embodiment, the upper surface of the planarization film 107). If filling is insufficient, defects such as voids may be generated in the formed planarization film 105. Shortening the filling step is advantageous in reducing defects such as voids.

Also, in the second embodiment, even if a foreign substance exists on the substrate 101 to be loaded into the planarization system, the foreign substance can be covered with the planarization film 107 formed in the first step. Hence, according to the second embodiment, it is possible to prevent or reduce damage to the superstrate 103 caused by collision of the foreign substance to the superstrate 103. The material of the substrate 101 and the composition of the curable composition 102 may be the same as in the first embodiment.

A more detailed example of the first step will be described below with reference to FIGS. 2A and 2B. First, in a liquid film forming step shown in FIG. 2A, the liquid film 106 can be formed on the substrate 101. Next, in a curing step shown in FIG. 2B, the liquid film 106 is cured in a state in which the upper surface of the liquid film 106 is exposed to the space above the liquid film 106, thereby forming the planarization film 107 (first planarization film). The method for executing the first step can comply with one of the three methods (the first method, the second method, and the third method) for executing the second step in the first embodiment. This will briefly be described below.

### First Method

In the first method, the first step can include the liquid film forming step of forming the liquid film 106 on the substrate 101 by a spin coating method (FIG. 2A), and the curing step of curing the liquid film 106 in a state in which the upper surface of the liquid film 106 is exposed to the space above the liquid film 106 (FIG. 2B). The material that forms the liquid film 106 can be, for example, a Spin On Carbon (SOC) material or a Spin On Glass (SOG) material. The curing step can include a liquid film curing step of curing the liquid film 106 by heating the liquid film 106. If the second step includes a heat curing step, the liquid film curing step of the first step and the heat curing step of the second step may be executed by the same heat treatment apparatus or different heat treatment apparatuses.

### Second Method

In the second method, the first step can include the liquid film forming step of forming the liquid film 106 (FIG. 2A), and the curing step of curing the liquid film 106 in a state in which the upper surface of the liquid film 106 is exposed to the space above the liquid film 106 (FIG. 2B). The liquid film forming step can include a film forming step of forming a first liquid material film made of a first liquid material on the substrate 101. The liquid film forming step can also include an arranging step of arranging a plurality of droplets made of a second liquid material on the first liquid material film, and a waiting step of waiting until a film made of the first liquid material and the second liquid material is formed as the liquid film 106. The curing step can include the liquid film curing step of curing the liquid film 106 by heating the liquid film 106. If the second step includes the heat curing step, the liquid film curing step of the first step and the heat curing step of the second step may be executed by the same heat treatment apparatus or different heat treatment apparatuses. A first liquid curable composition (A1) as the first liquid material and the second liquid curable composition (A2) as the second liquid material can comply with the first embodiment.

### Third Method

In the third method, the first step can include the liquid film forming step of forming the liquid film 106 (FIG. 2A), and the curing step of curing the liquid film 106 in a state in which the upper surface of the liquid film 106 is exposed to the space above the liquid film 106 (FIG. 2B). The liquid film forming step can include an arranging step of arranging a plurality of droplets made of a liquid material on the substrate 101, and a waiting step of waiting until the liquid film 106 is formed by the plurality of droplets in a state in which the plurality of droplets are exposed to the space above the liquid film 106. The curing step can include the liquid film curing step of curing the liquid film 106 by heating the liquid film 106. If the second step includes the heat curing step, the liquid film curing step of the first step and the heat curing step of the second step may be executed by the same heat treatment apparatus or different heat treatment apparatuses. A curable composition (A) as the liquid material can comply with the first embodiment.

A more detailed example of the second step will be described below with reference to FIGS. 2C to 2F. First, in an arranging step shown in FIG. 2C, a plurality of droplets of the curable composition 102 can be arranged on the planarization film 107 (first planarization film). Next, in a contact step shown in FIG. 2D, the superstrate 103 is brought into contact with the plurality of droplets of the curable composition 102 arranged on the planarization film 107, thereby forming a composition film 104 formed by the bond of the plurality of droplets. In a photocuring step shown in FIG. 2E, the composition film 104 is irradiated with light as curing energy CE and thus cured. The planarization film 105 made of a cured product of the curable composition 102 (composition film 104) can thus be formed. After that, in a separation step shown in FIG. 2F, the superstrate 103 can be separated from the planarization film 105. That is, the second step can include the arranging step, the contact step, and the photocuring step. Alternatively, the second step can include the arranging step, the contact step, the photocuring step, and the separation step. The second step may further include a heat curing step of heating the composition film 104 (planarization film 105) that has undergone the photocuring step, thereby further curing the composition film 104 (planarization film 105). In this case, the separation step of separating the superstrate 103 from the planarization film 105 may be executed before the heat curing step or after the heat curing step.

The planarization method and the article manufacturing method according to the second embodiment may further include a step of forming an adhesion layer (not shown) on the substrate 101. In this case, in the first step, the planarization film 107 can be formed on the adhesion layer.

The article manufacturing method according to the second embodiment includes, after the step of forming the planarization film 107 of the first layer and the planarization film 105 of the second layer by the planarization method exemplarily shown in FIGS. 2A to 2F, a processing step of processing the substrate with the planarization film 107 of the first layer and the planarization film 105 of the second layer formed thereon, thereby obtaining an article. The processing step can comply with the first embodiment.

### Third Embodiment

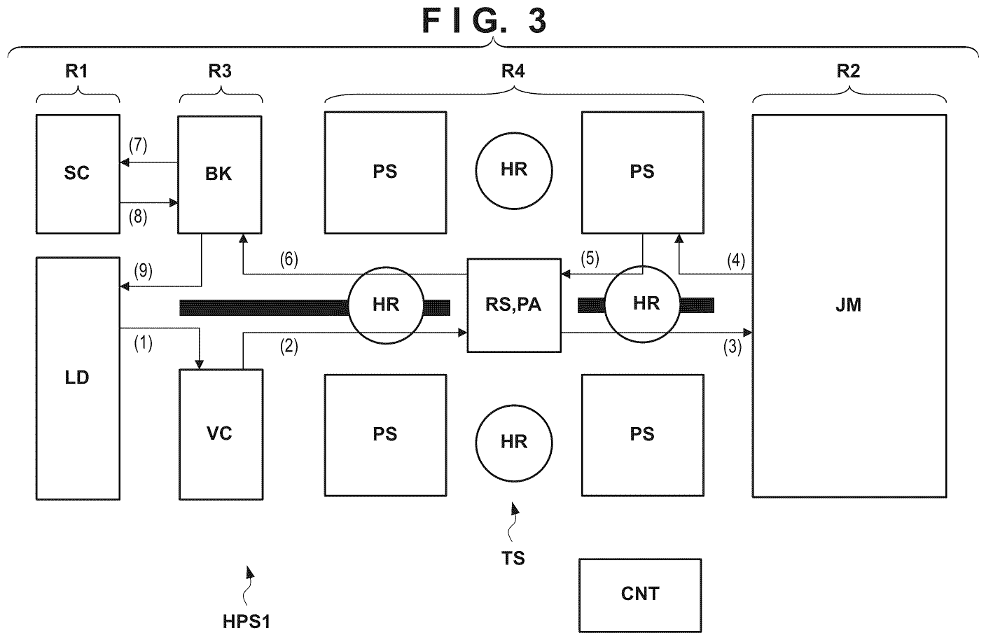

The third embodiment will be described below with reference to FIG. 3. The third embodiment is related to a planarization system HPS1 applicable to the planarization method according to the first or second embodiment. The planarization system HPS1 is a hybrid planarization system that forms a planarization film having a two-layered structure by two types of methods. The planarization system HPS1 can include a first planarization apparatus PS and a second planarization apparatus SC. The planarization system HPS1 may include one or a plurality of additional first planarization apparatuses PS and/or one or a plurality of additional second planarization apparatuses SC. In the example shown in FIG. 3, the planarization system HPS1 includes four first planarization apparatuses PS and one second planarization apparatus SC. The number of first planarization apparatuses PS and the number of second planarization apparatuses SC can each be decided in accordance with the processing time of a substrate 101 by these.

The first planarization apparatus PS brings a superstrate 103 into contact with a plurality of droplets of a curable composition 102 arranged on the substrate 101, thereby forming a planarization film 105. The second planarization apparatus SC forms a liquid film 106 by a spin coating method. The method of forming the liquid film 106 by the spin coating method can comply with the above-described first method. The planarization system HPS1 can also include a heat treatment apparatus BK that performs a heat treatment for curing the liquid film 106 formed by the second planarization apparatus SC. The planarization system HPS1 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101.

The planarization system HPS1 can further include a droplet arrangement apparatus JM that arranges a plurality of droplets of the curable composition 102 on the substrate 101. The substrate 101 on which the plurality of droplets of the curable composition 102 are arranged by the droplet arrangement apparatus JM can be supplied, by the conveyance mechanism TS, to a first planarization apparatus PS selected from the plurality of first planarization apparatuses PS. Alternatively, the first planarization apparatus PS may have a droplet arrangement function of arranging a plurality of droplets of the curable composition 102 on the substrate 101.

The heat treatment apparatus BK may perform not only the heat treatment for curing the liquid film 106 formed by the second planarization apparatus SC but also a heat treatment for further curing the planarization film 105 formed by the first planarization apparatus PS. Alternatively, the planarization system HPS1 may include an additional heat treatment apparatus that performs the heat treatment for further curing the planarization film 105 formed by the first planarization apparatus PS. Alternatively, the first planarization apparatus PS may have a heat treatment function of performing the additional heat treatment.

The planarization system HPS1 can further include an adhesion layer forming apparatus VC that forms an adhesion layer on the substrate 101 supplied to the first planarization apparatus PS and the second planarization apparatus SC. Here, the substrate 101 with the adhesion layer formed thereon by the adhesion layer forming apparatus VC can be supplied to the first planarization apparatus PS and then to the second planarization apparatus SC. However, the substrate 101 may be supplied to the second planarization apparatus SC and then to the first planarization apparatus PS.

The planarization system HPS1 can further include a loading apparatus LD that loads the substrate 101 into the planarization system HPS1. The loading apparatus LD can have a function of unloading the substrate 101 from the planarization system HPS1. The loading apparatus LD may be an Equipment Front End Module (EFEM). The planarization system HPS1 can include a controller CNT that controls the constituent elements (PS, SC, JM, BK, VC, TS, LD, and the like) of the planarization system HPS1. The controller CNT can be formed by, for example, a PLD (a short for Programmable Logic Device) such as an FPGA (a short for Field Programmable Gate Array), an ASIC (a short for Application Specific Integrated Circuit), a general-purpose or dedicated computer with programs installed therein, or a combination of some or all of these.

The heat treatment apparatus BK, the adhesion layer forming apparatus VC, and the plurality of first planarization apparatuses PS can be arranged between a first region R1 in which the loading apparatus LD is arranged and a second region R2 in which the droplet arrangement apparatus JM is arranged. The second planarization apparatus SC can be arranged in the first region R1. The heat treatment apparatus BK and the adhesion layer forming apparatus VC can be arranged in a third region R3 between the first region R1 and the second region R2. The plurality of first planarization apparatuses PS can be arranged in a fourth region R4 between the third region R3 and the second region R2.

In FIG. 3, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 3 is suitable for the planarization method according to the first embodiment. However, the moving path of the substrate 101 shown in FIG. 3 is merely an example, and the substrate 101 may be conveyed through another path. For example, the planarization system HPS1 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the first planarization apparatus PS selected from the plurality of first planarization apparatuses PS, and the first planarization apparatus PS can form the planarization film 105. Next, the substrate 101 can be conveyed by the conveyance mechanism TS from the first planarization apparatus PS to the heat treatment apparatus BK, and the heat treatment apparatus BK can perform the heat treatment. Next, the substrate 101 can be conveyed by the conveyance mechanism TS from the heat treatment apparatus BK to the second planarization apparatus SC, and the second planarization apparatus SC can form the liquid film 106 on the planarization film 105. Next, the substrate 101 can be conveyed by the conveyance mechanism TS from the second planarization apparatus SC to the heat treatment apparatus BK, and the heat treatment apparatus BK can perform the heat treatment. The liquid film 106 can thus be cured to form the planarization film 107. Next, the substrate 101 can be conveyed by the conveyance mechanism TS from the heat treatment apparatus BK to the loading apparatus LD.

### Fourth Embodiment

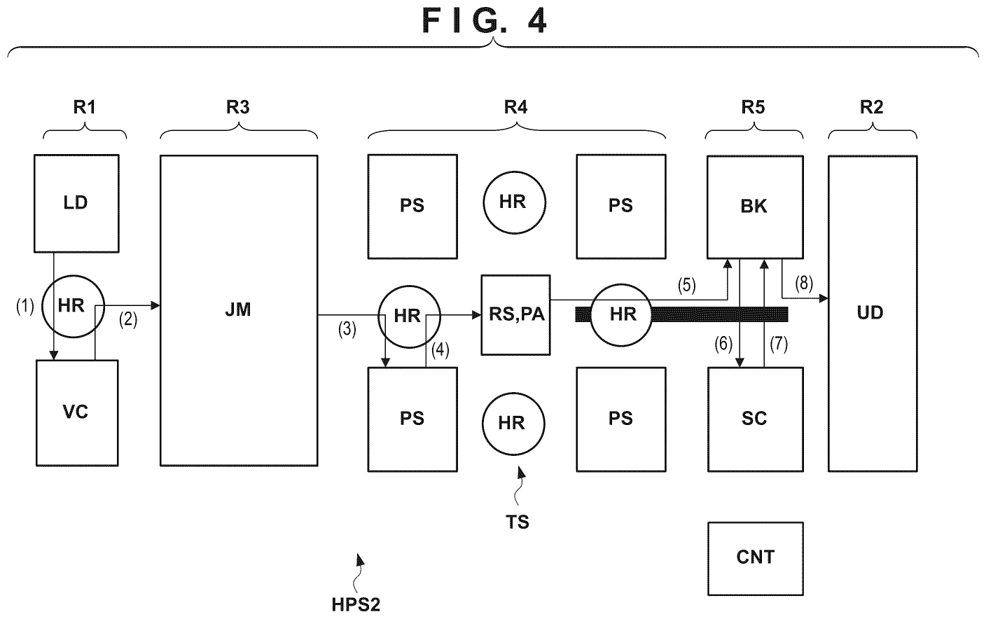

The fourth embodiment will be described below with reference to FIG. 4. The fourth embodiment is related to a planarization system HPS2 applicable to the planarization method according to the first or second embodiment. The planarization system HPS2 is a hybrid planarization system that forms a planarization film having a two-layered structure by two types of methods. The planarization system HPS2 can include a first planarization apparatus PS and a second planarization apparatus SC. The planarization system HPS2 may include one or a plurality of additional first planarization apparatuses PS and/or one or a plurality of additional second planarization apparatuses SC. In the example shown in FIG. 4, the planarization system HPS2 includes four first planarization apparatuses PS and one second planarization apparatus SC. The number of first planarization apparatuses PS and the number of second planarization apparatuses SC can each be decided in accordance with the processing time of a substrate 101 by these.

The first planarization apparatus PS brings a superstrate 103 into contact with a plurality of droplets of a curable composition 102 arranged on the substrate 101, thereby forming a planarization film 105. The second planarization apparatus SC forms a liquid film 106 by a spin coating method. The method of forming the liquid film 106 by the spin coating method can comply with the above-described first method. The planarization system HPS2 can also include a heat treatment apparatus BK that performs a heat treatment for curing the liquid film 106 formed by the second planarization apparatus SC. The planarization system HPS2 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101.

The planarization system HPS2 can further include a droplet arrangement apparatus JM that arranges a plurality of droplets of the curable composition 102 on the substrate 101. The substrate 101 on which the plurality of droplets of the curable composition 102 are arranged by the droplet arrangement apparatus JM can be supplied, by the conveyance mechanism TS, to a first planarization apparatus PS selected from the plurality of first planarization apparatuses PS. Alternatively, the first planarization apparatus PS may have a droplet arrangement function of arranging a plurality of droplets of the curable composition 102 on the substrate 101.

The heat treatment apparatus BK may perform not only the heat treatment for curing the liquid film 106 formed by the second planarization apparatus SC but also a heat treatment for further curing the planarization film 105 formed by the first planarization apparatus PS. Alternatively, the planarization system HPS2 may include an additional heat treatment apparatus that performs the heat treatment for further curing the planarization film 105 formed by the first planarization apparatus PS. Alternatively, the first planarization apparatus PS may have a heat treatment function of performing the additional heat treatment.

The planarization system HPS2 can further include an adhesion layer forming apparatus VC that forms an adhesion layer on the substrate 101 supplied to the first planarization apparatus PS and the second planarization apparatus SC. Here, the substrate 101 with the adhesion layer formed thereon by the adhesion layer forming apparatus VC can be supplied to the first planarization apparatus PS and then to the second planarization apparatus SC. However, the substrate 101 may be supplied to the second planarization apparatus SC and then to the first planarization apparatus PS.

The planarization system HPS2 can further include a loading apparatus LD that loads the substrate 101 into the planarization system HPS2, and an unloading apparatus UD that unloads the substrate 101 from the planarization system HPS2. The loading apparatus LD and the unloading apparatus UD may each be an EFEM. The planarization system HPS2 can include a controller CNT that controls the constituent elements (PS, SC, JM, BK, VC, TS, LD, UD, and the like) of the planarization system HPS2. The controller CNT can be formed by, for example, a PLD such as an FPGA, an ASIC, a general-purpose or dedicated computer with programs installed therein, or a combination of some or all of these.

The droplet arrangement apparatus JM, the plurality of first planarization apparatuses PS, the heat treatment apparatus BK, and the second planarization apparatus SC can be arranged between a first region R1 in which the loading apparatus LD is arranged and a second region R2 in which the unloading apparatus UD is arranged. The adhesion layer forming apparatus VC can be arranged in the first region R1. The plurality of first planarization apparatuses PS, the heat treatment apparatus BK, and the second planarization apparatus SC can be arranged between a third region R3 in which the droplet arrangement apparatus JM is arranged and the second region R2. The plurality of first planarization apparatuses PS can be arranged in a fourth region R4 between the third region R3 and the second region R2. The heat treatment apparatus BK and the second planarization apparatus SC can be arranged in a fifth region R5 between the fourth region R4 and the second region R2.

In FIG. 4, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 4 is suitable for the planarization method according to the first embodiment. However, the moving path of the substrate 101 shown in FIG. 4 is merely an example, and the substrate 101 may be conveyed through another path. For example, the planarization system HPS2 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the first planarization apparatus PS selected from the plurality of first planarization apparatuses PS, and the first planarization apparatus PS can form the planarization film 105. Next, the substrate 101 can be conveyed by the conveyance mechanism TS from the first planarization apparatus PS to the heat treatment apparatus BK, and the heat treatment apparatus BK can perform the heat treatment. Next, the substrate 101 can be conveyed by the conveyance mechanism TS from the heat treatment apparatus BK to the second planarization apparatus SC, and the second planarization apparatus SC can form the liquid film 106 on the planarization film 105. Next, the substrate 101 can be conveyed by the conveyance mechanism TS from the second planarization apparatus SC to the heat treatment apparatus BK, and the heat treatment apparatus BK can perform the heat treatment. The liquid film 106 can thus be cured to form the planarization film 107. Next, the substrate 101 can be conveyed by the conveyance mechanism TS from the heat treatment apparatus BK to the unloading apparatus UD.

### Fifth Embodiment

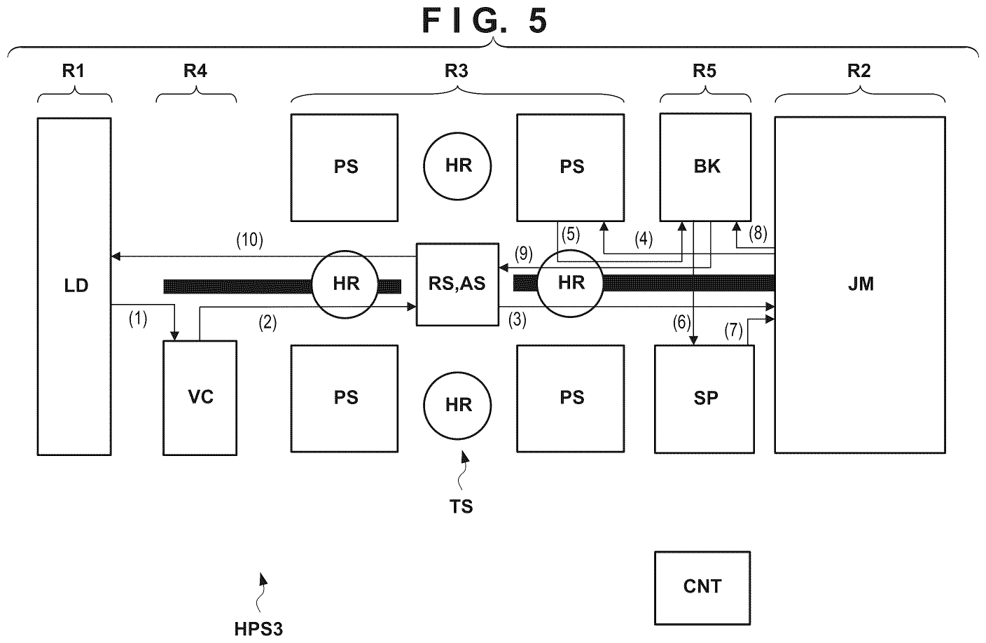

The fifth embodiment will be described below with reference to FIG. 5. The fifth embodiment is related to a planarization system HPS3 applicable to the planarization method according to the first or second embodiment. The planarization system HPS3 is a hybrid planarization system that forms a planarization film having a two-layered structure by two types of methods. The planarization system HPS3 is configured to form a planarization film 107 in accordance with the above-described second method.

The planarization system HPS3 can include a planarization apparatus PS, a droplet arrangement apparatus JM, a spin coater SP, and a heat treatment apparatus BK. The planarization system HPS3 may include one or a plurality of additional planarization apparatuses PS. In the example shown in FIG. 5, the planarization system HPS3 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate 101, thereby forming a planarization film 105. The spin coater SP can form a first liquid material film made of a first liquid material on the substrate 101. The droplet arrangement apparatus JM can be configured not only to arrange a plurality of droplets of the curable composition 102 on the substrate 101 supplied to the planarization apparatus PS but also to arrange a plurality of droplets made of a second liquid material on the first liquid material film formed by the spin coater SP. When the plurality of droplets made of the second liquid material are arranged on the first liquid material film, each of the plurality of droplets made of the second liquid material spreads, and a liquid film 106 made of the first liquid material and the second liquid material is formed.

The droplet arrangement apparatus JM can include a first nozzle that drops the plurality of droplets of the curable composition 102 on the substrate 101 supplied to the planarization apparatus PS, and a second nozzle that drops the plurality of droplets made of the second liquid material on the first liquid material film formed by the spin coater SP. Alternatively, the droplet arrangement apparatus JM may include a first droplet dispenser that arranges the plurality of droplets of the curable composition 102 on the substrate 101, and a second droplet dispenser that arranges the plurality of droplets made of the second liquid material on the first liquid material film. The substrate 101 for which the plurality of droplets made of the second liquid material are arranged on the first liquid material film by the droplet arrangement apparatus JM is supplied to the heat treatment apparatus BK. The heat treatment for forming the planarization film 107 by the heat treatment apparatus BK is started after the liquid film 106 made of the first liquid material and the second liquid material is formed.

The heat treatment apparatus BK may be controlled to perform a heat treatment for further curing the planarization film 105 formed by the planarization apparatus PS. Alternatively, the heat treatment apparatus BK may include a first heat treatment section that performs the heat treatment for forming the planarization film 107, and a second heat treatment section that performs the heat treatment for further curing the planarization film 105 formed by the planarization apparatus PS. Alternatively, the planarization system HPS3 may include an additional heat treatment apparatus that performs the heat treatment for further curing the planarization film 105 formed by the planarization apparatus PS.

The planarization system HPS3 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS3 can further include an adhesion layer forming apparatus VC that forms an adhesion layer on the substrate 101. The planarization system HPS3 can further include a loading apparatus LD that loads the substrate 101 into the planarization system HPS3. The loading apparatus LD can have a function of unloading the substrate 101 from the planarization system HPS3. The loading apparatus LD may be an EFEM.

The planarization system HPS3 can include a controller CNT that controls the constituent elements (PS, SP, JM, BK, VC, TS, LD, and the like) of the planarization system HPS3. The controller CNT can be formed by, for example, a PLD such as an FPGA, an ASIC, a general-purpose or dedicated computer with programs installed therein, or a combination of some or all of these.

The adhesion layer forming apparatus VC, the plurality of planarization apparatuses PS, the heat treatment apparatus BK, and the spin coater SP can be arranged between a first region R1 in which the loading apparatus LD is arranged and a second region R2 in which the droplet arrangement apparatus JM is arranged. The adhesion layer forming apparatus VC can be arranged in a fourth region R4 between a third region R3 in which the plurality of planarization apparatuses PS are arranged and the first region R1. The heat treatment apparatus BK and the spin coater SP can be arranged between the third region R3 and the second region R2.

In FIG. 5, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 5 is suitable for the planarization method according to the first embodiment. However, the moving path of the substrate 101 shown in FIG. 5 is merely an example, and the substrate 101 may be conveyed through another path. For example, the planarization system HPS3 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the heat treatment apparatus BK, and the heat treatment apparatus BK can perform the heat treatment. Next, the substrate 101 can be conveyed by the conveyance mechanism TS from the heat treatment apparatus BK to the spin coater SP, and the spin coater SP can form the first liquid material film made of the first liquid material on the planarization film 105. Next, the substrate 101 can be conveyed by the conveyance mechanism TS from the spin coater SP to the droplet arrangement apparatus JM, and the droplet arrangement apparatus JM can arrange a plurality of droplets made of the second liquid material on the first liquid material film. When the plurality of droplets made of the second liquid material are arranged on the first liquid material film, each of the plurality of droplets made of the second liquid material spreads, and the liquid film 106 made of the first liquid material and the second liquid material is formed. Next, the substrate 101 can be conveyed by the conveyance mechanism TS from the droplet arrangement apparatus JM to the heat treatment apparatus BK, and the heat treatment apparatus BK can perform the heat treatment. The liquid film 106 can thus be cured to form the planarization film 107. Next, the substrate 101 can be conveyed by the conveyance mechanism TS from the heat treatment apparatus BK to the loading apparatus LD.

### Sixth Embodiment

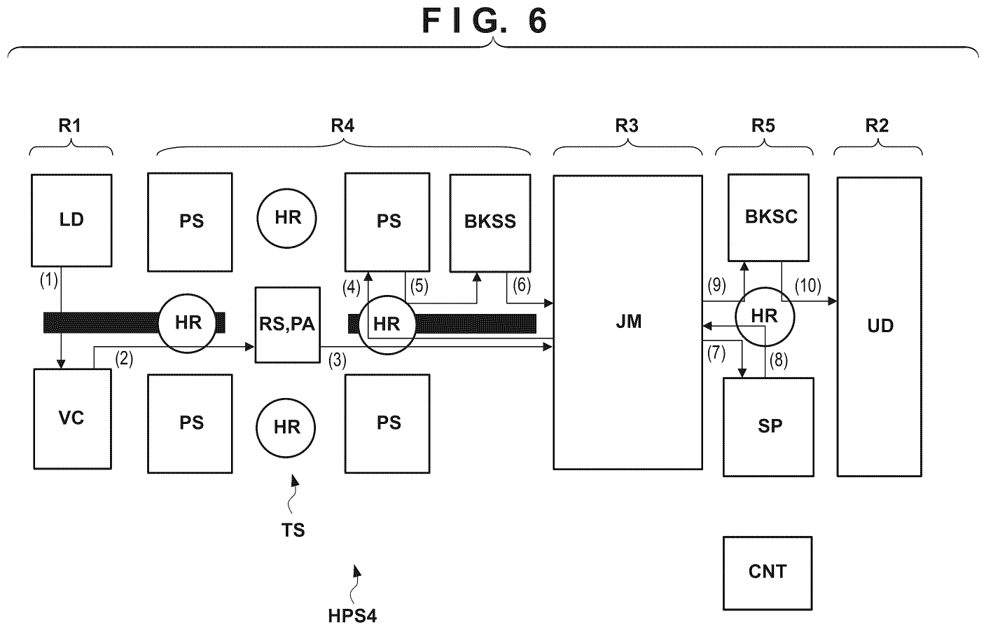

The sixth embodiment will be described below with reference to FIG. 6. The sixth embodiment is related to a planarization system HPS4 applicable to the planarization method according to the first or second embodiment. The planarization system HPS4 is a hybrid planarization system that forms a planarization film having a two-layered structure by two types of methods. The planarization system HPS4 is configured to form a planarization film 107 in accordance with the above-described second method.

The planarization system HPS4 can include a planarization apparatus PS, a droplet arrangement apparatus JM, a spin coater SP, a first heat treatment apparatus BKSC, and a second heat treatment apparatus BKSS. The planarization system HPS4 may include one or a plurality of additional planarization apparatuses PS. In the example shown in FIG. 6, the planarization system HPS4 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate 101, thereby forming a planarization film 105. The spin coater SP can form a first liquid material film made of a first liquid material on the substrate 101. The droplet arrangement apparatus JM can be configured not only to arrange a plurality of droplets of the curable composition 102 on the substrate 101 supplied to the planarization apparatus PS but also to arrange a plurality of droplets made of a second liquid material on the first liquid material film formed by the spin coater SP. When the plurality of droplets made of the second liquid material are arranged on the first liquid material film, each of the plurality of droplets made of the second liquid material spreads, and a liquid film 106 made of the first liquid material and the second liquid material is formed.

The droplet arrangement apparatus JM can include a first nozzle that drops the plurality of droplets of the curable composition 102 on the substrate 101 supplied to the planarization apparatus PS, and a second nozzle that drops the plurality of droplets made of the second liquid material on the first liquid material film formed by the spin coater SP. Alternatively, the droplet arrangement apparatus JM may include a first droplet dispenser that arranges the plurality of droplets of the curable composition 102 on the substrate 101, and a second droplet dispenser that arranges the plurality of droplets made of the second liquid material on the first liquid material film. The substrate 101 for which the plurality of droplets made of the second liquid material are arranged on the first liquid material film by the droplet arrangement apparatus JM is supplied to the first heat treatment apparatus BKSC. The heat treatment for forming the planarization film 107 by the first heat treatment apparatus BKSC is started after the liquid film 106 made of the first liquid material and the second liquid material is formed. The second heat treatment apparatus BKSS may be controlled to perform a heat treatment for further curing the planarization film 105 formed by the planarization apparatus PS.

The planarization system HPS4 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS4 can further include an adhesion layer forming apparatus VC that forms an adhesion layer on the substrate 101. The planarization system HPS4 can further include a loading apparatus LD that loads the substrate 101 into the planarization system HPS4, and an unloading apparatus UD that unloads the substrate 101 from the planarization system HPS4. The loading apparatus LD and the unloading apparatus UD may each be an EFEM.

The planarization system HPS4 can include a controller CNT that controls the constituent elements (PS, SP, JM, BKSC, BKSS, VC, TS, LD, UD, and the like) of the planarization system HPS4. The controller CNT can be formed by, for example, a PLD such as an FPGA, an ASIC, a general-purpose or dedicated computer with programs installed therein, or a combination of some or all of these.

The plurality of planarization apparatuses PS, the second heat treatment apparatus BKSS, the droplet arrangement apparatus JM, the first heat treatment apparatus BKSC, and the spin coater SP can be arranged between a first region R1 in which the loading apparatus LD is arranged and a second region R2 in which the unloading apparatus UD is arranged. The plurality of planarization apparatuses PS and the second heat treatment apparatus BKSS can be arranged between a third region R3 in which the droplet arrangement apparatus JM is arranged and the first region R1. The first heat treatment apparatus BKSC and the spin coater SP can be arranged between the third region R3 and the second region R2. The adhesion layer forming apparatus VC can be arranged in the first region R1.

In FIG. 6, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 6 is suitable for the planarization method according to the first embodiment. However, the moving path of the substrate 101 shown in FIG. 6 is merely an example, and the substrate 101 may be conveyed through another path. For example, the planarization system HPS4 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the second heat treatment apparatus BKSS, and the second heat treatment apparatus BKSS can perform the heat treatment. Next, the substrate 101 can be conveyed by the conveyance mechanism TS from the second heat treatment apparatus BKSS to the spin coater SP, and the spin coater SP can form the first liquid material film made of the first liquid material on the planarization film 105. Next, the substrate 101 can be conveyed by the conveyance mechanism TS from the spin coater SP to the droplet arrangement apparatus JM, and the droplet arrangement apparatus JM can arrange a plurality of droplets made of the second liquid material on the first liquid material film. When the plurality of droplets made of the second liquid material are arranged on the first liquid material film, each of the plurality of droplets made of the second liquid material spreads, and the liquid film 106 made of the first liquid material and the second liquid material is formed. Next, the substrate 101 can be conveyed by the conveyance mechanism TS from the droplet arrangement apparatus JM to the first heat treatment apparatus BKSC, and the first heat treatment apparatus BKSC can perform the heat treatment. The liquid film 106 can thus be cured to form the planarization film 107. Next, the substrate 101 can be conveyed by the conveyance mechanism TS from the first heat treatment apparatus BKSC to the unloading apparatus UD.

### Seventh Embodiment

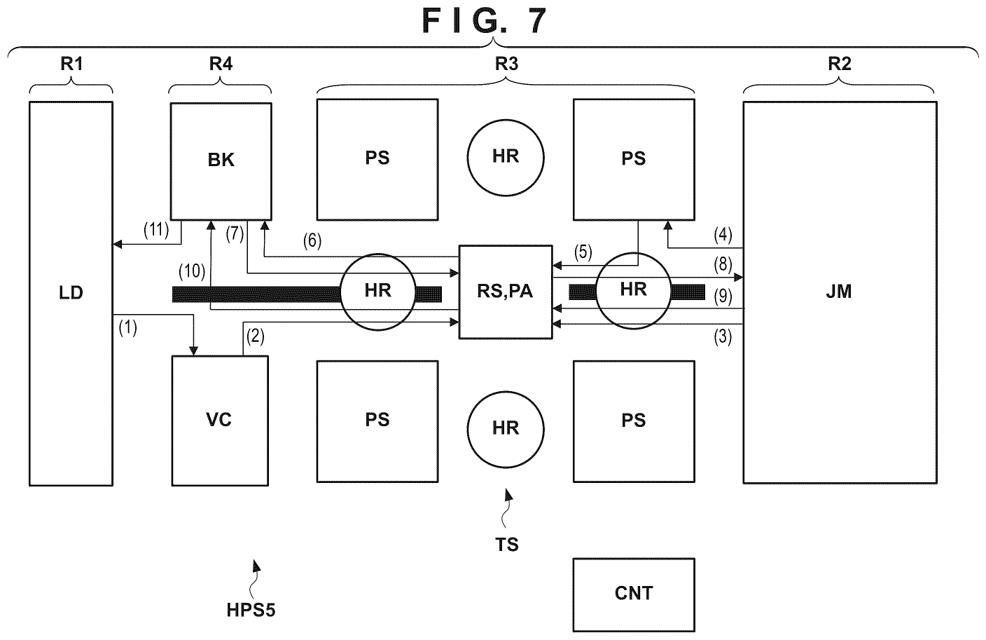

The seventh embodiment will be described below with reference to FIG. 7. The seventh embodiment is related to a planarization system HPS5 applicable to the planarization method according to the first or second embodiment. The planarization system HPS5 is a hybrid planarization system that forms a planarization film having a two-layered structure by two types of methods. The planarization system HPS5 is configured to form a planarization film 107 in accordance with the above-described third method.

The planarization system HPS5 can include a planarization apparatus PS, a droplet arrangement apparatus JM, and a heat treatment apparatus BK. The planarization system HPS5 may include one or a plurality of additional planarization apparatuses PS. In the example shown in FIG. 7, the planarization system HPS5 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate, thereby forming a planarization film 105. The droplet arrangement apparatus JM can be configured not only to arrange a plurality of droplets of the curable composition 102 on the substrate 101 supplied to the planarization apparatus PS but also to arrange a plurality of droplets made of a liquid material on the substrate 101. In a state in which the plurality of droplets made of the liquid material are exposed to the space above them, each of the plurality of droplets spreads, and a liquid film 106 made of the liquid material is formed.

The droplet arrangement apparatus JM can include a first nozzle that drops the plurality of droplets of the curable composition 102 on the substrate 101 to form the planarization film 105, and a second nozzle that drops the plurality of droplets made of the liquid material on the substrate 101 to form the planarization film 107. Alternatively, the droplet arrangement apparatus JM can include a first droplet dispenser that arranges the plurality of droplets of the curable composition 102 on the substrate 101 to form the planarization film 105, and a second droplet dispenser that arranges the plurality of droplets made of the liquid material on the substrate 101 to form the planarization film 107. The substrate 101 for which the plurality of droplets made of the liquid material are arranged by the droplet arrangement apparatus JM to form the planarization film 107 is supplied to the heat treatment apparatus BK. The heat treatment for forming the planarization film 107 by the heat treatment apparatus BK is started after the liquid film 106 is formed by the plurality of droplets made of the liquid material.

The heat treatment apparatus BK may be controlled to perform a heat treatment for further curing the planarization film 105 formed by the planarization apparatus PS. Alternatively, the heat treatment apparatus BK may include a first heat treatment section that performs the heat treatment for forming the planarization film 107, and a second heat treatment section that performs the heat treatment for further curing the planarization film 105 formed by the planarization apparatus PS. Alternatively, the planarization system HPS5 may include an additional heat treatment apparatus that performs the heat treatment for further curing the planarization film 105 formed by the planarization apparatus PS.

The planarization system HPS5 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS5 can further include an adhesion layer forming apparatus VC that forms an adhesion layer on the substrate 101. The planarization system HPS5 can further include a loading apparatus LD that loads the substrate 101 into the planarization system HPS5. The loading apparatus LD can have a function of unloading the substrate 101 from the planarization system HPS5. The loading apparatus LD may be an EFEM.

The planarization system HPS5 can include a controller CNT that controls the constituent elements (PS, JM, BK, VC, TS, and the like) of the planarization system HPS5. The controller CNT can be formed by, for example, a PLD such as an FPGA, an ASIC, a general-purpose or dedicated computer with programs installed therein, or a combination of some or all of these.

The adhesion layer forming apparatus VC, the heat treatment apparatus BK, and the plurality of planarization apparatuses PS can be arranged between a first region R1 in which the loading apparatus LD is arranged and a second region R2 in which the droplet arrangement apparatus JM is arranged. The adhesion layer forming apparatus VC and the heat treatment apparatus BK can be arranged in a fourth region R4 between a third region R3 in which the plurality of planarization apparatuses PS are arranged and the first region R1.

In FIG. 7, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 7 is suitable for the planarization method according to the first embodiment. However, the moving path of the substrate 101 shown in FIG. 7 is merely an example, and the substrate 101 may be conveyed through another path. For example, the planarization system HPS5 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the heat treatment apparatus BK, and the heat treatment apparatus BK can perform the heat treatment. Next, the substrate 101 can be conveyed by the conveyance mechanism TS from the heat treatment apparatus BK to the droplet arrangement apparatus JM, and the droplet arrangement apparatus JM can arrange a plurality of droplets made of the liquid material on the planarization film 105. Each of the plurality of droplets made of the liquid material arranged on the planarization film 105 spreads, and the liquid film 106 made of the liquid material is formed. Next, the substrate 101 can be conveyed by the conveyance mechanism TS from the droplet arrangement apparatus JM to the heat treatment apparatus BK, and the heat treatment apparatus BK can perform the heat treatment. The liquid film 106 can thus be cured to form the planarization film 107. Next, the substrate 101 can be conveyed by the conveyance mechanism TS from the heat treatment apparatus BK to the loading apparatus LD.

### Eighth Embodiment

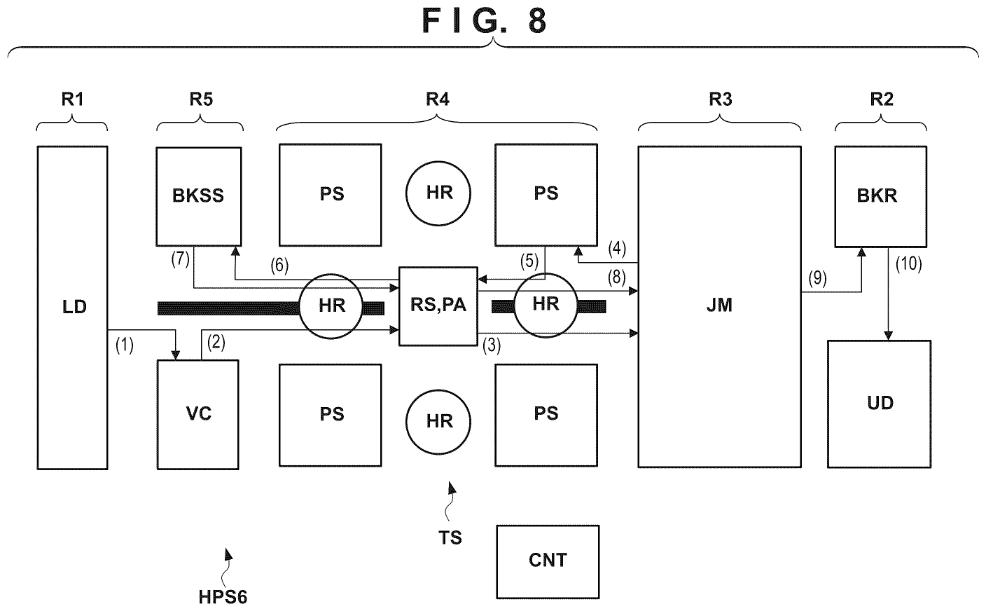

The eighth embodiment will be described below with reference to FIG. 8. The eighth embodiment is related to a planarization system HPS6 applicable to the planarization method according to the first or second embodiment. The planarization system HPS6 is a hybrid planarization system that forms a planarization film having a two-layered structure by two types of methods. The planarization system HPS6 is configured to form a planarization film 107 in accordance with the above-described third method.

The planarization system HPS6 can include a planarization apparatus PS, a droplet arrangement apparatus JM, a first heat treatment apparatus BKR, and a second heat treatment apparatus BKSS. The planarization system HPS6 may include one or a plurality of additional planarization apparatuses PS. In the example shown in FIG. 8, the planarization system HPS6 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate, thereby forming a planarization film 105. The droplet arrangement apparatus JM can be configured not only to arrange a plurality of droplets of the curable composition 102 on the substrate 101 supplied to the planarization apparatus PS but also to arrange a plurality of droplets made of a liquid material on the substrate 101. In a state in which the plurality of droplets made of the liquid material are exposed to the space above them, each of the plurality of droplets spreads, and a liquid film 106 made of the liquid material is formed.

The droplet arrangement apparatus JM can include a first nozzle that drops the plurality of droplets of the curable composition 102 on the substrate 101 to form the planarization film 105, and a second nozzle that drops the plurality of droplets made of the liquid material on the substrate 101 to form the planarization film 107. Alternatively, the droplet arrangement apparatus JM can include a first droplet dispenser that arranges the plurality of droplets of the curable composition 102 on the substrate 101 to form the planarization film 105, and a second droplet dispenser that arranges the plurality of droplets made of the liquid material on the substrate 101 to form the planarization film 107. The substrate 101 for which the plurality of droplets made of the liquid material are arranged by the droplet arrangement apparatus JM to form the planarization film 107 is supplied to the first heat treatment apparatus BKR. The heat treatment for forming the planarization film 107 by the first heat treatment apparatus BKR is started after the liquid film 106 is formed by the plurality of droplets made of the liquid material. The second heat treatment apparatus BKSS can be controlled to perform a heat treatment for further curing the planarization film 105 formed by the planarization apparatus PS.

The planarization system HPS6 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS6 can further include an adhesion layer forming apparatus VC that forms an adhesion layer on the substrate 101. The planarization system HPS6 can further include a loading apparatus LD that loads the substrate 101 into the planarization system HPS6, and an unloading apparatus UD that unloads the substrate 101 from the planarization system HPS6. The loading apparatus LD and the unloading apparatus UD may each be an EFEM.

The planarization system HPS6 can include a controller CNT that controls the constituent elements (PS, JM, BKR, BKSS, VC, TS, LD, UD, and the like) of the planarization system HPS6. The controller CNT can be formed by, for example, a PLD such as an FPGA, an ASIC, a general-purpose or dedicated computer with programs installed therein, or a combination of some or all of these.

The plurality of planarization apparatuses PS, the second heat treatment apparatus BKSS, the droplet arrangement apparatus JM, and the first heat treatment apparatus BKR can be arranged between a first region R1 in which the loading apparatus LD is arranged and a second region R2 in which the unloading apparatus UD is arranged. The plurality of planarization apparatuses PS and the second heat treatment apparatus BKSS can be arranged between a third region R3 in which the droplet arrangement apparatus JM is arranged and the first region R1. The first heat treatment apparatus BKR can be arranged in the second region R2. The second heat treatment apparatus BKSS and the adhesion layer forming apparatus VC can be arranged in a fifth region R5 between a fourth region R4 in which the plurality of planarization apparatuses PS are arranged and the first region R1.

In FIG. 8, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 8 is suitable for the planarization method according to the first embodiment. However, the moving path of the substrate 101 shown in FIG. 8 is merely an example, and the substrate 101 may be conveyed through another path. For example, the planarization system HPS6 may operate to execute the planarization method according to the second embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the second heat treatment apparatus BKSS, and the second heat treatment apparatus BKSS can perform the heat treatment. Next, the substrate 101 can be conveyed by the conveyance mechanism TS from the second heat treatment apparatus BKSS to the droplet arrangement apparatus JM, and the droplet arrangement apparatus JM can arrange a plurality of droplets made of the liquid material on the planarization film 105. Each of the plurality of droplets made of the liquid material arranged on the planarization film 105 spreads, and the liquid film 106 made of the liquid material is formed. Next, the substrate 101 can be conveyed by the conveyance mechanism TS from the droplet arrangement apparatus JM to the first heat treatment apparatus BKR, and the first heat treatment apparatus BKR can perform the heat treatment. The liquid film 106 can thus be cured to form the planarization film 107. Next, the substrate 101 can be conveyed by the conveyance mechanism TS from the first heat treatment apparatus BKR to the unloading apparatus UD.

### Ninth Embodiment

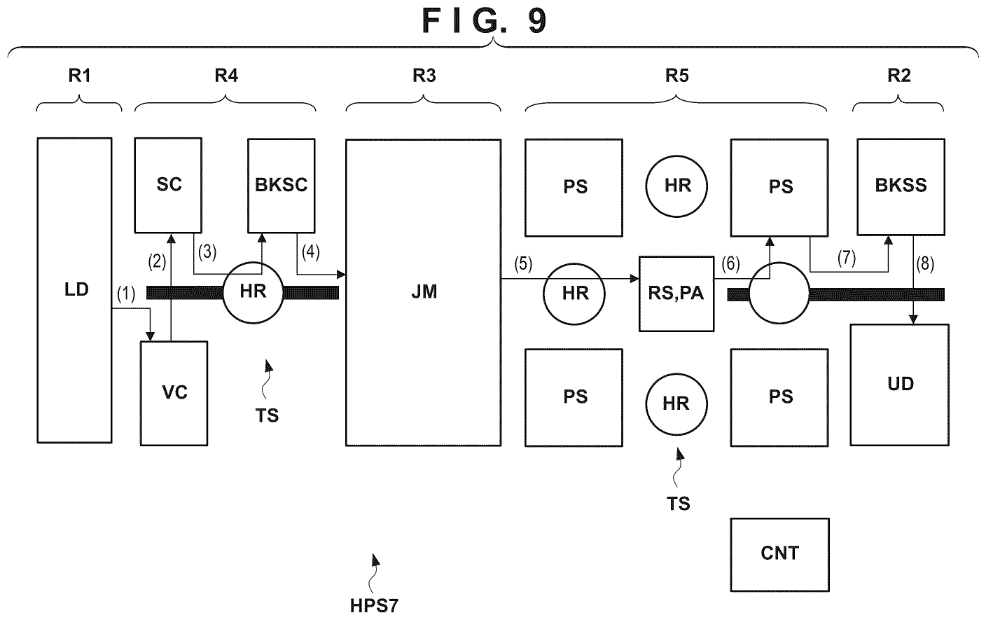

The ninth embodiment will be described below with reference to FIG. 9. The ninth embodiment is related to a planarization system HPS7 applicable to the planarization method according to the first or second embodiment. The planarization system HPS7 is a hybrid planarization system that forms a planarization film having a two-layered structure by two types of methods. The planarization system HPS7 can include a first planarization apparatus PS and a second planarization apparatus SC. The planarization system HPS7 may include one or a plurality of additional first planarization apparatuses PS and/or one or a plurality of additional second planarization apparatuses SC. In the example shown in FIG. 9, the planarization system HPS7 includes four first planarization apparatuses PS and one second planarization apparatus SC. The number of first planarization apparatuses PS and the number of second planarization apparatuses SC can each be decided in accordance with the processing time of a substrate 101 by these.

The first planarization apparatus PS brings a superstrate 103 into contact with a plurality of droplets of a curable composition 102 arranged on the substrate 101, thereby forming a planarization film 105. The second planarization apparatus SC is a spin coater that forms a liquid film 106 by a spin coating method. The method of forming the liquid film 106 by the spin coating method can comply with the above-described first method. The planarization system HPS7 can also include a first heat treatment apparatus BKSC that performs a heat treatment for curing the liquid film 106 formed by the second planarization apparatus SC. The planarization system HPS7 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101.

The planarization system HPS7 can further include a droplet arrangement apparatus JM that arranges a plurality of droplets of the curable composition 102 on the substrate 101. The substrate 101 on which the plurality of droplets of the curable composition 102 are arranged by the droplet arrangement apparatus JM can be supplied, by the conveyance mechanism TS, to a first planarization apparatus PS selected from the plurality of first planarization apparatuses PS. Alternatively, the first planarization apparatus PS may have a droplet arrangement function of arranging a plurality of droplets of the curable composition 102 on the substrate 101.

The planarization system HPS7 may include a second heat treatment apparatus BKSS, and the second heat treatment apparatus BKSS can perform a heat treatment for further curing the planarization film 105 formed by the first planarization apparatus PS. Alternatively, the first planarization apparatus PS may have a heat treatment function of performing an additional heat treatment. The first heat treatment apparatus BKSC and the second heat treatment apparatus BKSS may be commonized.

The planarization system HPS7 can further include an adhesion layer forming apparatus VC that forms an adhesion layer on the substrate 101 supplied to the first planarization apparatus PS and the second planarization apparatus SC. Here, the substrate 101 with the adhesion layer formed thereon by the adhesion layer forming apparatus VC can be supplied to the second planarization apparatus SC and then to the first planarization apparatus PS. However, the substrate 101 may be supplied to the first planarization apparatus PS and then to the second planarization apparatus SC.

The planarization system HPS7 can further include a loading apparatus LD that loads the substrate 101 into the planarization system HPS7, and an unloading apparatus UD that unloads the substrate 101 from the planarization system HPS7. The loading apparatus LD and the unloading apparatus UD may each be an EFEM. The planarization system HPS7 can include a controller CNT that controls the constituent elements (PS, SC, JM, BKSC, BKSS, VC, TS, LD, UD, and the like) of the planarization system HPS7. The controller CNT can be formed by, for example, a PLD such as an FPGA, an ASIC, a general-purpose or dedicated computer with programs installed therein, or a combination of some or all of these.

The second planarization apparatus SC (spin coater), the first heat treatment apparatus BKSC, the droplet arrangement apparatus JM, and the plurality of first planarization apparatuses PS can be arranged between a first region R1 in which the loading apparatus LD is arranged and a second region R2 in which the unloading apparatus UD is arranged. The droplet arrangement apparatus JM can be arranged in a third region R3 between the first region R1 and the second region R2. The second planarization apparatus SC (spin coater) and the first heat treatment apparatus BKSC can be arranged in a fourth region R4 between the first region R1 and the third region R3. The plurality of first planarization apparatuses PS can be arranged in a fifth region R5 between the second region R2 and the third region R3. The second heat treatment apparatus BKSS can be arranged in the second region R2. The second planarization apparatus SC (spin coater) can be arranged in the fourth region R4 between the first region R1 and the third region R3. The first heat treatment apparatus BKSC can be arranged between the second planarization apparatus SC (spin coater) and the third region R3. The adhesion layer forming apparatus VC can be arranged in the fourth region R4.

In FIG. 9, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 9 is suitable for the planarization method according to the second embodiment. However, the moving path of the substrate 101 shown in FIG. 9 is merely an example, and the substrate 101 may be conveyed through another path. For example, the planarization system HPS7 may operate to execute the planarization method according to the first embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the second planarization apparatus SC, and the second planarization apparatus SC can form the liquid film 106 on the planarization film 105. Next, the substrate 101 can be conveyed by the conveyance mechanism TS from the second planarization apparatus SC to the first heat treatment apparatus BKSC, and the first heat treatment apparatus BKSC can perform the heat treatment. The liquid film 106 can thus be cured to form the planarization film 107. Next, the substrate 101 can be conveyed by the conveyance mechanism TS from the first heat treatment apparatus BKSC to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the first planarization apparatus PS selected from the plurality of first planarization apparatuses PS, and the first planarization apparatus PS can form the planarization film 105. Next, the substrate 101 can be conveyed by the conveyance mechanism TS from the first planarization apparatus PS to the second heat treatment apparatus BKSS, and the second heat treatment apparatus BKSS can perform the heat treatment. Next, the substrate 101 can be conveyed by the conveyance mechanism TS from the second heat treatment apparatus BKSS to the unloading apparatus UD.

### 10th Embodiment

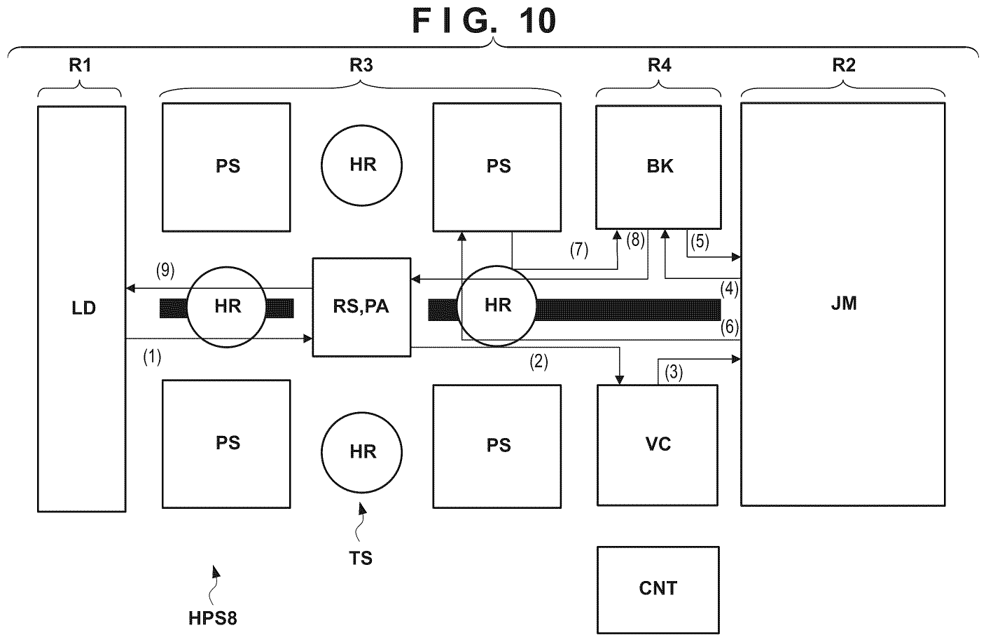

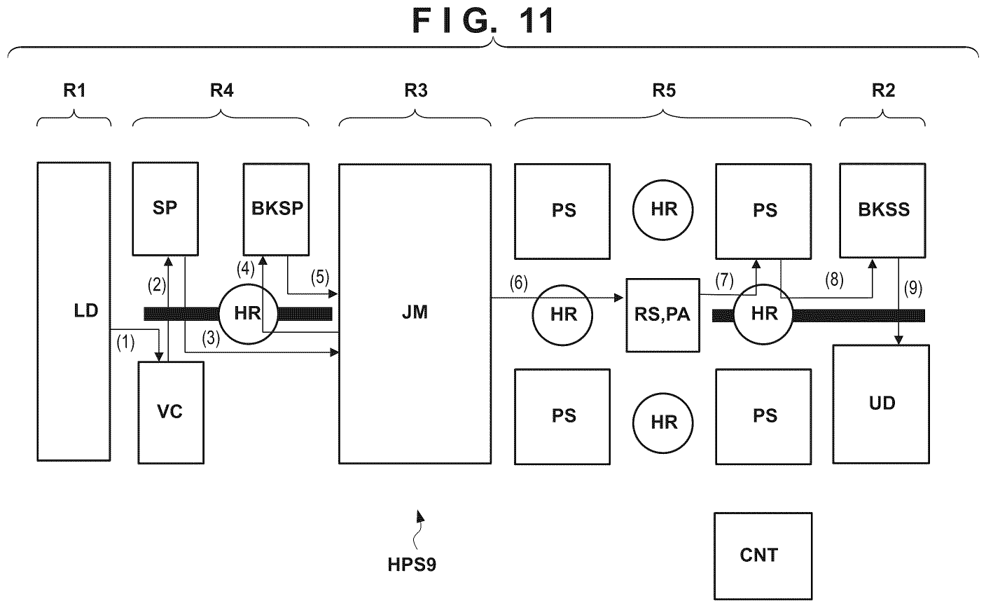

The 10th embodiment will be described below with reference to FIG. 10. The 10th embodiment is related to a planarization system HPS8 applicable to the planarization method according to the first or second embodiment. The planarization system HPS8 is a hybrid planarization system that forms a planarization film having a two-layered structure by two types of methods. The planarization system HPS8 is configured to form a planarization film 107 in accordance with the above-described third method.

The planarization system HPS8 can include a planarization apparatus PS, a droplet arrangement apparatus JM, and a heat treatment apparatus BK. The planarization system HPS8 may include one or a plurality of additional planarization apparatuses PS. In the example shown in FIG. 10, the planarization system HPS8 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate, thereby forming a planarization film 105. The droplet arrangement apparatus JM can be configured not only to arrange a plurality of droplets of the curable composition 102 on the substrate 101 supplied to the planarization apparatus PS but also to arrange a plurality of droplets made of a liquid material on the substrate 101. In a state in which the plurality of droplets made of the liquid material are exposed to the space above them, each of the plurality of droplets spreads, and a liquid film 106 made of the liquid material is formed.

The droplet arrangement apparatus JM can include a first nozzle that drops the plurality of droplets of the curable composition 102 on the substrate 101 to form the planarization film 105, and a second nozzle that drops the plurality of droplets made of the liquid material on the substrate 101 to form the planarization film 107. Alternatively, the droplet arrangement apparatus JM can include a first droplet dispenser that arranges the plurality of droplets of the curable composition 102 on the substrate 101 to form the planarization film 105, and a second droplet dispenser that arranges the plurality of droplets made of the liquid material on the substrate 101 to form the planarization film 107. The substrate 101 for which the plurality of droplets made of the liquid material are arranged by the droplet arrangement apparatus JM to form the planarization film 107 is supplied to the heat treatment apparatus BK. The heat treatment for forming the planarization film 107 by the heat treatment apparatus BK is started after the liquid film 106 is formed by the plurality of droplets made of the liquid material.

The heat treatment apparatus BK may be controlled to perform a heat treatment for further curing the planarization film 105 formed by the planarization apparatus PS. Alternatively, the heat treatment apparatus BK may include a first heat treatment section that performs the heat treatment for forming the planarization film 107, and a second heat treatment section that performs the heat treatment for further curing the planarization film 105 formed by the planarization apparatus PS. Alternatively, the planarization system HPS8 may include an additional heat treatment apparatus that performs the heat treatment for further curing the planarization film 105 formed by the planarization apparatus PS.

The planarization system HPS8 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS8 can further include an adhesion layer forming apparatus VC that forms an adhesion layer on the substrate 101. The planarization system HPS8 can further include a loading apparatus LD that loads the substrate 101 into the planarization system HPS8. The loading apparatus LD can have a function of unloading the substrate 101 from the planarization system HPS8. The loading apparatus LD may be an EFEM.

The planarization system HPS8 can include a controller CNT that controls the constituent elements (PS, JM, BK, VC, TS, and the like) of the planarization system HPS8. The controller CNT can be formed by, for example, a PLD such as an FPGA, an ASIC, a general-purpose or dedicated computer with programs installed therein, or a combination of some or all of these.

The plurality of planarization apparatuses PS and the heat treatment apparatus BK can be arranged between a first region R1 in which the loading apparatus LD is arranged and a second region R2 in which the droplet arrangement apparatus JM is arranged. The plurality of planarization apparatuses PS, the heat treatment apparatus BK, and the adhesion layer forming apparatus VC can be arranged between the first region R1 in which the loading apparatus LD is arranged and the second region R2 in which the droplet arrangement apparatus JM is arranged. The heat treatment apparatus BK and the adhesion layer forming apparatus VC can be arranged in a fourth region R4 between a third region R3 in which the plurality of planarization apparatuses PS are arranged and the second region R2 in which the droplet arrangement apparatus JM is arranged.

In FIG. 10, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 10 is suitable for the planarization method according to the second embodiment. However, the moving path of the substrate 101 shown in FIG. 10 is merely an example, and the substrate 101 may be conveyed through another path. For example, the planarization system HPS8 may operate to execute the planarization method according to the first embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the droplet arrangement apparatus JM, and the droplet arrangement apparatus JM can arrange a plurality of droplets made of the liquid material on the planarization film 105. Each of the plurality of droplets made of the liquid material arranged on the planarization film 105 spreads, and the liquid film 106 made of the liquid material is formed. Next, the substrate 101 can be conveyed by the conveyance mechanism TS from the droplet arrangement apparatus JM to the heat treatment apparatus BK, and the heat treatment apparatus BK can perform the heat treatment. The liquid film 106 can thus be cured to form the planarization film 107. Next, the substrate 101 can be conveyed by the conveyance mechanism TS from the heat treatment apparatus BK to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the heat treatment apparatus BK, and the heat treatment apparatus BK can perform the heat treatment. Next, the substrate 101 can be conveyed by the conveyance mechanism TS from the heat treatment apparatus BK to the loading apparatus LD.

### 11th Embodiment

The 11th embodiment will be described below with reference to FIG. 11. The 11th embodiment is related to a planarization system HPS9 applicable to the planarization method according to the first or second embodiment. The planarization system HPS9 is a hybrid planarization system that forms a planarization film having a two-layered structure by two types of methods. The planarization system HPS9 is configured to form a planarization film 107 in accordance with the above-described second method.

The planarization system HPS9 can include a planarization apparatus PS, a droplet arrangement apparatus JM, a spin coater SP, a first heat treatment apparatus BKSP (first heat treatment section), and a second heat treatment apparatus BKSS (second heat treatment section). The planarization system HPS9 may include one or a plurality of additional planarization apparatuses PS. In the example shown in FIG. 11, the planarization system HPS9 includes four planarization apparatuses PS. The number of planarization apparatuses PS can be decided in accordance with the processing time of a substrate 101 by the planarization apparatus PS.

The planarization apparatus PS brings a superstrate 103 into contact with a plurality of droplets of a curable composition 102 arranged on the substrate, thereby forming a planarization film 105. The spin coater SP can form a first liquid material film made of a first liquid material on the substrate 101. The droplet arrangement apparatus JM can be configured not only to arrange a plurality of droplets of the curable composition 102 on the substrate 101 supplied to the planarization apparatus PS but also to arrange a plurality of droplets made of a second liquid material on the first liquid material film formed by the spin coater SP. When the plurality of droplets made of the second liquid material are arranged on the first liquid material film, each of the plurality of droplets made of the second liquid material spreads, and a liquid film 106 made of the first liquid material and the second liquid material is formed.

The droplet arrangement apparatus JM can include a first nozzle that drops the plurality of droplets of the curable composition 102 on the substrate 101 supplied to the planarization apparatus PS, and a second nozzle that drops the plurality of droplets made of the second liquid material on the first liquid material film formed by the spin coater SP. Alternatively, the droplet arrangement apparatus JM may include a first droplet dispenser that arranges the plurality of droplets of the curable composition 102 on the substrate 101, and a second droplet dispenser that arranges the plurality of droplets made of the second liquid material on the first liquid material film. The substrate 101 for which the plurality of droplets made of the second liquid material are arranged on the first liquid material film by the droplet arrangement apparatus JM is supplied to the first heat treatment apparatus BKSP. The heat treatment for forming the planarization film 107 by the first heat treatment apparatus BKSP is started after the liquid film 106 made of the first liquid material and the second liquid material is formed.

The second heat treatment apparatus BKSS can be controlled to perform a heat treatment for further curing the planarization film 105 formed by the planarization apparatus PS. Alternatively, the first heat treatment apparatus BKSP and the second heat treatment apparatus BKSS may be commonized.

The planarization system HPS9 can also include a conveyance mechanism TS that conveys the substrate 101. The conveyance mechanism TS can include one or a plurality of robots HR that convey or manipulate the substrate 101. The conveyance mechanism TS can include a relay section RS that relays the substrate 101, and a prealigner PA that prealigns the substrate 101. The planarization system HPS9 can further include an adhesion layer forming apparatus VC that forms an adhesion layer on the substrate 101. The planarization system HPS9 can further include a loading apparatus LD that loads the substrate 101 into the planarization system HPS9, and an unloading apparatus UD that unloads the substrate 101 from the planarization system HPS9. The loading apparatus LD and the unloading apparatus UD may each be an EFEM.

The planarization system HPS9 can include a controller CNT that controls the constituent elements (PS, SP, JM, BKSP, BKSS, VC, TS, LD, UD, and the like) of the planarization system HPS9. The controller CNT can be formed by, for example, a PLD such as an FPGA, an ASIC, a general-purpose or dedicated computer with programs installed therein, or a combination of some or all of these.

The spin coater SP, the first heat treatment apparatus BKSP, the droplet arrangement apparatus JM, and the plurality of planarization apparatuses PS can be arranged between a first region R1 in which the loading apparatus LD is arranged and a second region R2 in which the unloading apparatus UD is arranged. The second heat treatment apparatus BKSS can be arranged in the second region R2. The droplet arrangement apparatus JM can be arranged in a third region R3 between the first region R1 and the second region R2. The spin coater SP and the first heat treatment apparatus BKSP can be arranged in a fourth region R4 between the first region R1 and the third region R3. The plurality of planarization apparatuses PS can be arranged in a fifth region R5 between the third region R3 and the second region R2. The adhesion layer forming apparatus VC can be arranged in the fourth region R4.

In FIG. 11, the moving path of the substrate 101 is exemplarily indicated by arrows with bracketed numbers. The bracketed numbers indicate the order of movement of the substrate 101. The movement of the substrate 101 can be controlled by the controller CNT programmed in advance. The moving path of the substrate 101 shown in FIG. 11 is suitable for the planarization method according to the second embodiment. However, the moving path of the substrate 101 shown in FIG. 11 is merely an example, and the substrate 101 may be conveyed through another path. For example, the planarization system HPS9 may operate to execute the planarization method according to the first embodiment.

The substrate 101 can be conveyed by the conveyance mechanism TS from the loading apparatus LD to the adhesion layer forming apparatus VC, and the adhesion layer forming apparatus VC can form the adhesion layer on the substrate 101. Next, the substrate 101 can be conveyed by the conveyance mechanism TS from the adhesion layer forming apparatus VC to the spin coater SP, and the spin coater SP can form the first liquid material film made of the first liquid material on the planarization film 105. Next, the substrate 101 can be conveyed by the conveyance mechanism TS from the spin coater SP to the droplet arrangement apparatus JM, and the droplet arrangement apparatus JM can arrange a plurality of droplets made of the second liquid material on the first liquid material film. When the plurality of droplets made of the second liquid material are arranged on the first liquid material film, each of the plurality of droplets made of the second liquid material spreads, and the liquid film 106 made of the first liquid material and the second liquid material is formed. Next, the substrate 101 can be conveyed by the conveyance mechanism TS from the droplet arrangement apparatus JM to first heat treatment apparatus BKSP, and the first heat treatment apparatus BKSP can perform the heat treatment. The liquid film 106 can thus be cured to form the planarization film 107. Next, the substrate 101 can be conveyed by the conveyance mechanism TS from the first heat treatment apparatus BKSP to the droplet arrangement apparatus JM, and the droplet arrangement apparatus JM can arrange a plurality of droplets of the curable composition 102 on the substrate 101. Next, the substrate 101 can be conveyed by the conveyance mechanism TS from the droplet arrangement apparatus JM to the planarization apparatus PS selected from the plurality of planarization apparatuses PS, and the planarization apparatus PS can form the planarization film 105. Next, the substrate 101 can be conveyed by the conveyance mechanism TS from the planarization apparatus PS to the second heat treatment apparatus BKSS, and the second heat treatment apparatus BKSS can perform the heat treatment. Next, the substrate 101 can be conveyed by the conveyance mechanism TS from the second heat treatment apparatus BKSS to the loading apparatus LD.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The disclosure in the specification and the drawings include the following.
(Item 1) A planarization method comprising:
   forming a first planarization film by forming a liquid film on a substrate and curing the liquid film in a state in which an upper surface of the liquid film is exposed to a space above the liquid film; and
   forming a second planarization film by a curable composition on the first planarization film using a superstrate.
(Item 2) The method according to item 1, wherein
   the forming the first planarization film comprises:
   forming the liquid film by a spin coating method; and
   curing the liquid film in the state in which the upper surface of the liquid film is exposed to the space above the liquid film.
(Item 3) The method according to item 1, wherein
   the forming the first planarization film comprises:
   forming a first liquid material film made of a first liquid material on the substrate;
   arranging a plurality of droplets made of a second liquid material on the first liquid material film;
   waiting until a film made of the first liquid material and the second liquid material is formed as the liquid film; and
   curing the liquid film in the state in which the upper surface of the liquid film is exposed to the space above the liquid film.
(Item 4) The method according to item 1, wherein
   the forming the first planarization film comprises:
   arranging a plurality of droplets made of a liquid material on the substrate;
   waiting until the liquid film is formed by the plurality of droplets in a state in which the plurality of droplets are exposed to the space; and
   curing the liquid film in the state in which the upper surface of the liquid film is exposed to the space above the liquid film.
(Item 5) The method according to any one of items 1 to 4, further comprising
   forming an adhesion layer on the substrate,
   wherein in the forming the first planarization film, the first planarization film is formed on the adhesion layer.
(Item 6) The method according to any one of items 1 to 5, wherein
   the forming the second planarization film comprises:
   arranging a plurality of droplets of the curable composition on the first planarization film;
   forming a composition film by bringing the superstrate into contact with the plurality of droplets; and
   curing the composition film by irradiating the composition film with light.
(Item 7) The method according to item 6, wherein
   the forming the second planarization film further comprises further curing the composition film by heating the composition film that has undergone the curing the composition film.
(Item 8) The method according to item 2, wherein
   the forming the first planarization film comprises curing the liquid film by heating the liquid film formed by the spin coating method.
(Item 9). The method according to item 8, wherein
   the forming the second planarization film comprises:
   arranging a plurality of droplets of the curable composition on the substrate;
   forming a composition film by bringing the superstrate into contact with the plurality of droplets; and
   curing the composition film by irradiating the composition film with light.
(Item 10) The method according to item 9, wherein
   the forming the second planarization film further comprises further curing the composition film by heating the composition film that has undergone the curing the composition film.
(Item 11) The method according to item 10, wherein the curing the liquid film in the forming the first planarization film and the further curing the composition film in the forming the second planarization film are executed by the same heat treatment apparatus.
(Item 12) The method according to item 3, wherein
   the forming the first planarization film comprises curing the liquid film by heating the liquid film.
(Item 13) The method according to item 12, wherein
   the forming the second planarization film comprises:
   arranging a plurality of droplets of the curable composition on the substrate;
   forming a composition film by bringing the superstrate into contact with the plurality of droplets; and
   curing the composition film by irradiating the composition film with light.
(Item 14) The method according to item 13, wherein
   the forming the first planarization film further comprises further curing the composition film by heating the composition film that has undergone the curing the composition film.
(Item 15) The method according to claim item 14, wherein
   the curing the liquid film in the forming the first planarization film and the further curing the composition film in the forming the second planarization film are executed by the same heat treatment apparatus.
(Item 16) The method according to item 14 or 15, wherein the arranging in the forming the first planarization film and the arranging in the forming the second planarization film are executed by the same droplet arrangement apparatus.
(Item 17) The method according to item 4, wherein
   the forming the first planarization film comprises curing the liquid film by heating the liquid film.
(Item 18) The method according to item 17, wherein
   the forming the second planarization film comprises:
   arranging a plurality of droplets of the curable composition on the substrate;
   forming a composition film by bringing the superstrate into contact with the plurality of droplets; and
   curing the composition film by irradiating the composition film with light.
(Item 19) The method according to claim item 18, wherein
   the forming the second planarization film further comprises further curing the composition film by heating the composition film that has undergone the curing the composition film.
(Item 20) The method according to item 19, wherein the curing the liquid film in the forming the first planarization film and the further curing the composition film in the forming the second planarization film are executed by the same heat treatment apparatus.
(Item 21) The method according to item 19 or 20, wherein the arranging in the forming the first planarization film and the arranging in the forming the second planarization film are executed by the same droplet arrangement apparatus.
(Item 22) An article manufacturing method comprising:
   forming a first planarization film and a second planarization film on a substrate by a planarization method defined as any one of items 1 to 21; and
   processing the substrate with the first planarization film and the second planarization film formed thereon, thereby obtaining an article.

This application claims the benefit of Japanese Patent Application No. 2024-143353, filed Aug. 23, 2024 and Japanese Patent Application No. 2024-143354, filed Aug. 23, 2024, which are hereby incorporated by reference herein in their entirety.

What is claimed is:

1. A planarization system comprising:
a spin coater configured to form a liquid film on a substrate by a spin coating method;
a heat treatment apparatus configured to perform a heat treatment for curing the liquid film formed by the spin coater;
a droplet arrangement apparatus configured to arrange a plurality of droplets of a curable composition on the substrate;
a planarization apparatus configured to form a planarization film by bringing a superstrate into contact with the plurality of droplets of the curable composition arranged on the substrate by the droplet arrangement apparatus; and
a conveyance mechanism configured to convey the substrate to the spin coater, the heat treatment apparatus, the droplet arrangement apparatus, and the planarization apparatus in this order.

2. The system according to claim 1, further comprising
a second heat treatment apparatus configured to perform a heat treatment for curing the liquid film formed by the planarization apparatus,
wherein the conveyance mechanism conveys the substrate to the spin coater, the heat treatment apparatus, the droplet arrangement apparatus, the planarization apparatus, and the second heat treatment apparatus in this order.

3. The system according to claim 2, further comprising:
a loading apparatus configured to load the substrate; and
an unloading apparatus configured to unload the substrate,
wherein the spin coater, the heat treatment apparatus, the droplet arrangement apparatus, and the planarization apparatus are arranged between a first region in which the loading apparatus is arranged and a second region in which the unloading apparatus is arranged.

4. The system according to claim 3, wherein
the droplet arrangement apparatus is arranged in a third region between the first region and the second region, the spin coater and the heat treatment apparatus are arranged between the first region and the third region, and the planarization apparatus is arranged between the second region and the third region.

5. The system according to claim 4, wherein
the second heat treatment apparatus is arranged in the second region.

6. The system according to claim 5, wherein
the spin coater is arranged in a fourth region between the first region and the third region, and the heat treatment apparatus is arranged between the spin coater and the third region.

7. The system according to claim 6, further comprising
an adhesion layer forming apparatus configured to form an adhesion layer on the substrate supplied to the spin coater,
wherein the adhesion layer forming apparatus is arranged in the fourth region.

8. A planarization system comprising:
a planarization apparatus configured to form a planarization film by bringing a superstrate into contact with a curable composition arranged on a substrate;
a droplet arrangement apparatus configured to arrange a plurality of droplets on the substrate;
a heat treatment apparatus configured to, after the plurality of droplets arranged on the substrate by the droplet arrangement apparatus bond to each other to form a liquid film, further perform a heat treatment for curing the liquid film and a heat treatment for further curing the planarization film formed by the planarization apparatus; and
a conveyance mechanism configured to convey the substrate to the droplet arrangement apparatus, the heat treatment apparatus, the droplet arrangement apparatus, the planarization apparatus, and the heat treatment apparatus in this order.

9. The system according to claim 8, further comprising
a spin coater configured to form a first liquid material film made of a first liquid material on the substrate,
wherein the droplet arrangement apparatus arranges the curable composition on the substrate supplied to the planarization apparatus and also arranges a plurality of droplets made of a second liquid material on the first liquid material film formed by the spin coater, and
the substrate for which the plurality of droplets made of the second liquid material are arranged on the first liquid material film by the droplet arrangement apparatus is supplied to the heat treatment apparatus.

10. The system according to claim 8, further comprising
an adhesion layer forming apparatus configured to form an adhesion layer on the substrate,
wherein the substrate on which the adhesion layer is formed by the adhesion layer forming apparatus is supplied to the droplet arrangement apparatus.

11. The system according to claim 9, further comprising
an adhesion layer forming apparatus configured to form an adhesion layer on the substrate,
wherein the substrate on which the adhesion layer is formed by the adhesion layer forming apparatus is supplied to the spin coater.

12. The system according to claim 8, further comprising
a loading apparatus configured to load the substrate,
wherein the planarization apparatus and the heat treatment apparatus are arranged between the loading apparatus and the droplet arrangement apparatus.

13. The system according to claim 11, further comprising
a loading apparatus configured to load the substrate,
wherein the planarization apparatus, the heat treatment apparatus, and the adhesion layer forming apparatus are arranged between the loading apparatus and the droplet arrangement apparatus.

14. The system according to claim 10, wherein
the heat treatment apparatus and the adhesion layer forming apparatus are arranged between the planarization apparatus and the droplet arrangement apparatus.

15. The system according to claim 9, wherein
the heat treatment apparatus includes a first heat treatment section configured to, after the plurality of droplets of the curable composition arranged on the substrate by the droplet arrangement apparatus bond to each other to form the liquid film, perform the heat treatment for curing the liquid film, and a second heat treatment section configured to further perform the heat treatment for further curing the planarization film formed by the planarization apparatus.

16. The system according to claim 15, further comprising:
a loading apparatus configured to load the substrate; and
an unloading apparatus configured to unload the substrate,
wherein the spin coater, the first heat treatment section, the droplet arrangement apparatus, and the planarization apparatus are arranged between a first region in which the loading apparatus is arranged and a second region in which the unloading apparatus is arranged.

17. The system according to claim 16, wherein
the second heat treatment section is arranged in the second region.

18. The system according to claim 16, wherein
the droplet arrangement apparatus is arranged in a third region between the first region and the second region, the spin coater and the first heat treatment section are arranged between the first region and the third region, and the planarization apparatus is arranged between the third region and the second region.

19. The system according to claim 18, further comprising
an adhesion layer forming apparatus configured to form an adhesion layer on the substrate,
wherein the adhesion layer forming apparatus is arranged between the first region and the third region.
